(19) United States
(12) Patent Application Publication
(10) Pub. No.: US 2008/0289770 A1
(43) Pub. Date: Nov. 27, 2008

(54) Adhesive tape cutting device

(75) Inventors: Chun-Hua Hsia, Tien-Shui Chen (TW); Ching-Shun Wang, Tien-Shui Chen (TW); Ming-Chung Wang, Tien-Shui Chen (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: ADVANCED CONNECTION TECHNOLOGY INC., Tien-Shui Chen (TW)

(21) Appl. No.: 11/802,819

(22) Filed: May 25, 2007

(51) Int. Cl. B32B 38/10

(52) U.S. Cl. 156/510

(57) ABSTRACT

An adhesive tape cutting device includes: a sleeve body adapted to be sleeved on an adhesive tape roll and defining a channel that has opposite first and second open ends which open in opposite circumferential directions, the sleeve body further defining a tape-discharging slot that is disposed between the first and second open ends, that is in spatial communication with the channel, and that opens in a radial direction for extension of an unrolled end portion of an adhesive tape of the adhesive tape roll therethrough; and a cutting member mounted on the sleeve body.

### BACKGROUND OF THE INVENTION

1. Field of the Invention

The invention relates to an adhesive tape cutting device, more particularly to a hand held adhesive tape cutting device having a sleeve body adapted to be sleeved detachably on an adhesive tape roll.

2. Description of the Related Art

FIG. 1 illustrates a conventional hand held adhesive tape cutting device that includes an adhesive tape roll seat 55 provided with a mounting ring 58 that is adapted for mounting of an adhesive tape roll 6 thereon, a cutter-mounting member 56 pivoted to an upper wall of the adhesive tape roll seat 55, a cutting member 57 mounted on the cutter-mounting member 56, a guiding roller 59 mounted on the adhesive tape roll seat 55 and disposed below the cutter-mounting member 56, and an arcuate guiding plate 591 disposed adjacent to the guiding roller 59. In use, an unrolled end portion 610 of an adhesive tape 61 of the adhesive tape roll 6 is pulled over the arcuate guiding plate 591 and the guiding roller 59 so as to be cut by the cutting member 57. Since the mounting ring 58 is used to support the adhesive tape roll 6 thereon, it has a relatively large size, which results in an increase in the volume of the conventional adhesive tape cutting device.

### SUMMARY OF THE INVENTION

Therefore, the object of the present invention is to provide an adhesive tape cutting device that can overcome the aforesaid drawback associated with the prior art.

Accordingly, an adhesive tape cutting device of the present invention comprises: a sleeve body adapted to be sleeved on an adhesive tape roll and defining a channel that has opposite first and second open ends which open in opposite circumferential directions for extension of the adhesive tape roll therethrough, the sleeve body further defining a tape-discharging slot that is disposed between the first and second open ends, that is in spatial communication with the channel, and that opens in a radial direction for extension of an unrolled end portion of an adhesive tape of the adhesive tape roll therethrough; and a cutting member mounted on the sleeve body.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional view of a conventional adhesive tape cutting device;

FIG. 2 is an exploded perspective view of the preferred embodiment of an adhesive tape cutting device according to the present invention for cutting an adhesive tape of an adhesive tape roll;

FIG. 3 is an assembled perspective view of the preferred embodiment in a state of being sleeved on the adhesive tape roll;

FIG. 4 is a schematic side view of the preferred embodiment in a state of being sleeved on the adhesive tape roll;

FIG. 5 is a perspective view of the preferred embodiment in a state of use, illustrating how the adhesive tape is cut by a first cutting member of the preferred embodiment;

FIG. 6 is a perspective view of the preferred embodiment in a state of use, illustrating how the adhesive tape is cut by a second cutting member of the preferred embodiment; and

FIG. 7 is a schematic side view of the preferred embodiment, illustrating how the adhesive tape roll is urged to abut against a sleeve body by an urging member of the preferred embodiment.

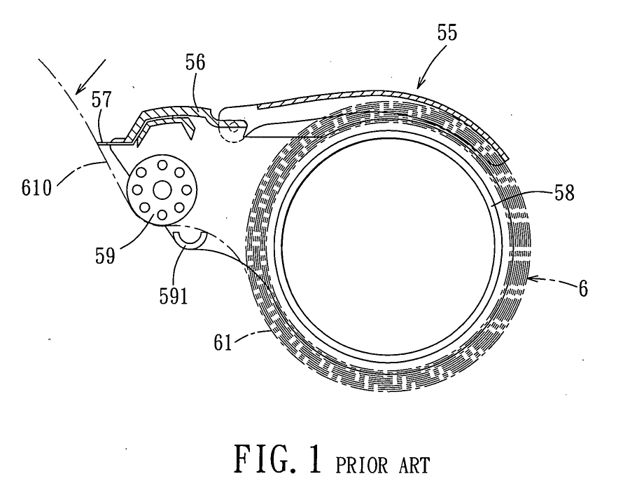

### DETAILED DESCRIPTION OF THE PREFERRED EMBODIMENT

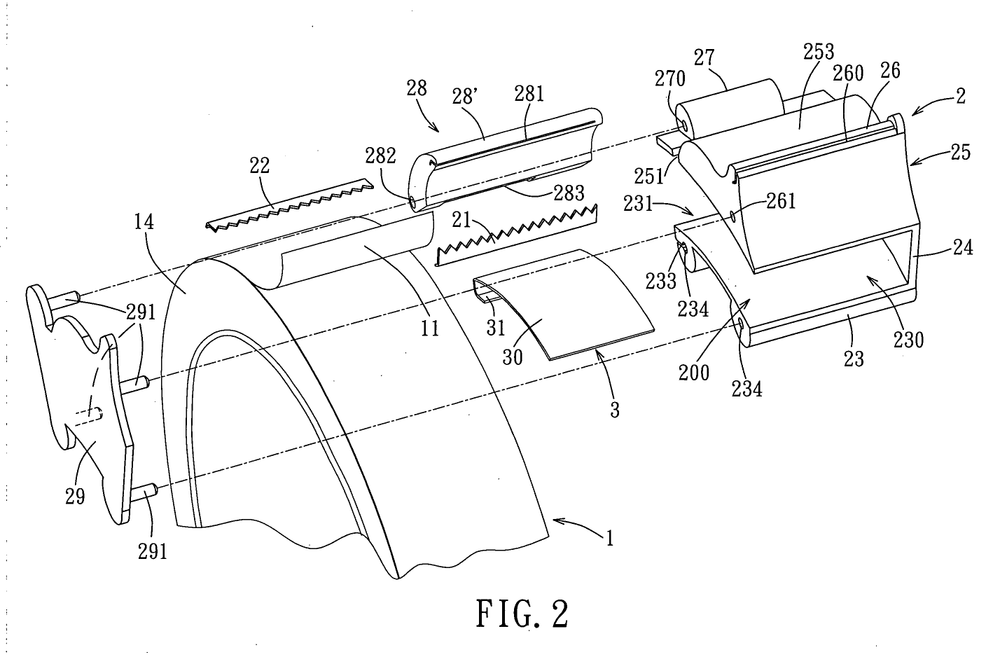

Referring to FIGS. 2 and 3, the preferred embodiment of an adhesive tape cutting device according to the present invention includes: a sleeve body 2 adapted to be sleeved detachably on a circumferentially extending segment of an adhesive tape roll 1 and defining a channel 200 that extends circumferentially and that has opposite first and second open ends 230, 231 which open in opposite circumferential directions for extension of the circumferentially extending segment therethrough, the sleeve body 2 further defining a tape-discharging slot 251 that is disposed between the first and second open ends 230, 231, that is in spatial communication with the channel 200, and that opens in a radial direction for extension of an unrolled end portion 11 of an adhesive tape 14 of the adhesive tape roll 1 therethrough; and a first cutting member 21 mounted on the sleeve body 2.

In this embodiment, the sleeve body 2 includes upper and lower walls 25, 23 and a side wall 24 interconnecting and cooperating with the upper and lower walls 25, 23 to define the channel 200 and the first and second open ends 230, 231. The first cutting member 21 is mounted on the upper wall 25, and the tape-discharging slot 251 is formed in the upper wall 25.

The sleeve body 2 further includes a cover 29 that is disposed opposite to the side wall 24 and that is detachably connected to the upper and lower walls 25, 23. The cover 29 is provided with four posts 291. The upper wall 25 is formed with holes 270, 261 and the lower wall 23 is formed with holes 234 for extension of the posts 291 of the cover 29 therein, respectively.

The upper wall 25 is formed with a cutter-mounting protrusion 26 that protrudes radially therefrom and that has a tapered end formed with a first cutter-retaining slit 260 for extension of the first cutting member 21 therein.

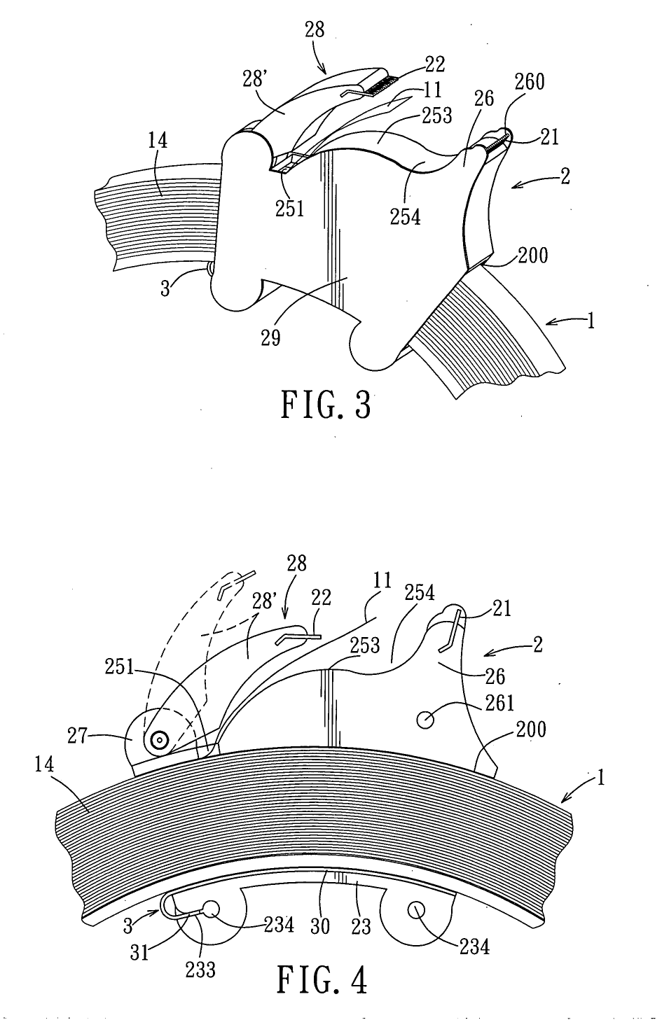

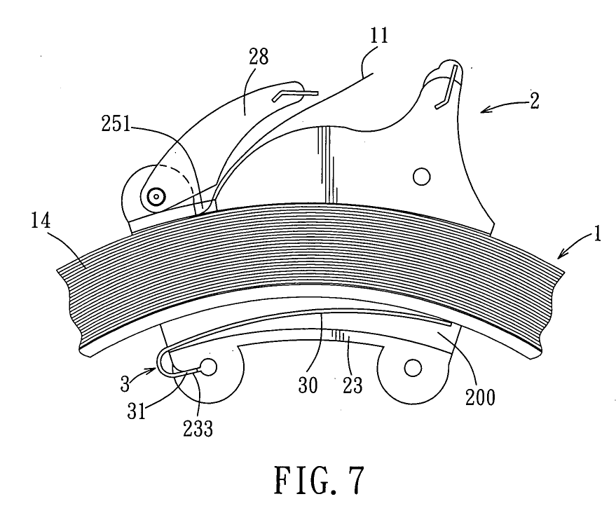

An urging member 3 is mounted on the lower wall 23 and extends into the channel 200 for urging an outer surface of the adhesive tape roll 1 to abut against the upper wall 25 (see FIGS. 4 and 7). In this embodiment, the lower wall 23 has an end portion formed with a retaining slit 233. The urging member 3 is in the form of a plate that has an arcuate spring arm portion 30 which extends circumferentially into the channel 200 and which is adapted to abut resiliently against an inner surface of the adhesive tape roll 1, and a bent end portion 31 turned from an end of the spring arm portion 30 and extending into the retaining slit 233. It is noted that the arcuate spring arm portion 30 of the urging member 3 ensures abutment of the adhesive tape roll 1 against the upper wall 25 when the thickness of the adhesive tape roll 1 is gradually decreased, as best illustrated in FIG. 7.

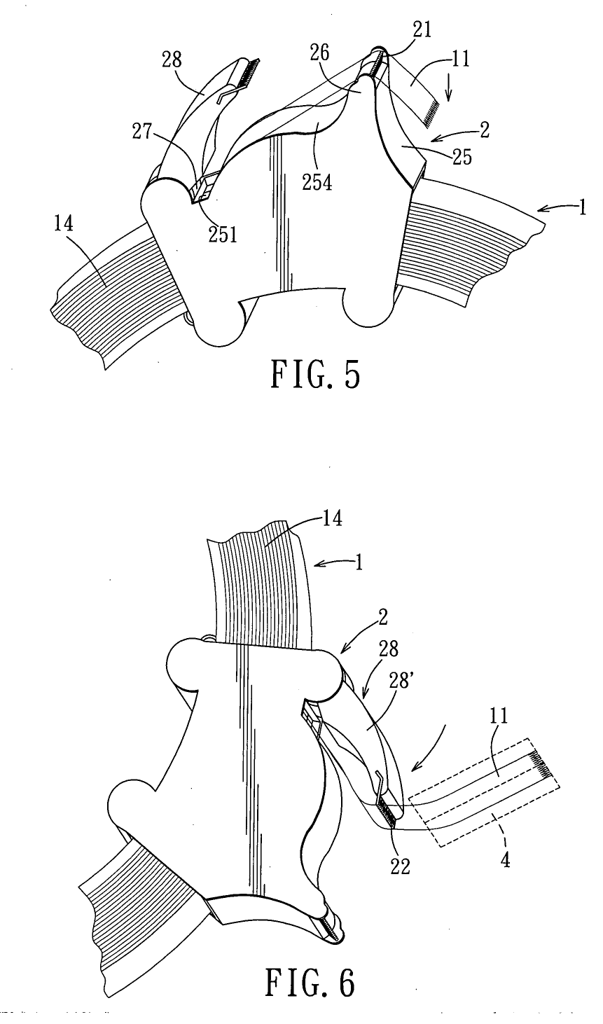

The upper wall 25 has an upper surface 253 extending curvedly from a periphery of the tape-discharging slot 251 to the tapered end of the cutter-mounting protrusion 26 and formed with a recess 254 disposed between the tape-discharging slot 251 and the first cutter-retaining slit 260. The recess 254 serves to facilitate the pulling operation of the unrolled end portion 11 of the adhesive tape 14 of the adhesive tape roll 1 toward the first cutting member 21 when the adhesive tape 14 of the adhesive tape roll 1 is to be cut at the cutter-mounting protrusion 26 by the first cutting member 21, as best illustrated in FIG. 5.

The adhesive tape cutting device further includes a second cutting member 22 mounted on the upper wall 25 and displaced angularly from the first cutting member 21. The upper wall 25 is formed with a pivot protrusion 27 which is formed with the hole 270. The sleeve body 2 further includes a cutter-mounting seat 28 pivoted to the pivot protrusion 27 and formed with a second cutter-retaining slit 281 for extension of the second cutting member 22 therein. The cutter-mounting seat 28 is further formed with a through-hole 282 aligned with the hole 270 in the pivot protrusion 27. One of the posts 291 of the cover 29 extends through the through-hole 282 in the cutter-mounting seat 28 and into the hole 270 in the pivot protrusion 27 so as to permit pivoting movement of the cutter-mounting seat 28. The tape-discharging slot 251 is disposed between the pivot protrusion 27 and the cutter-mounting protrusion 26. The cutter-mounting seat 28 includes an arcuate arm 28′ pivoted to the pivot protrusion 27 through the respective post 291 of the cover 29, extending therefrom toward the cutter-mounting protrusion 26, and pivotable relative to the upper wall 25, as best illustrated in FIG. 4. The arcuate arm 28′ is formed with a retaining recess 283 for extension of the pivot protrusion 27 therein. The second cutting member 22 is mounted on a free end of the arcuate arm 28′ so as to be disposed between the first cutting member 21 and the tape-discharging slot 251. FIG. 6 illustrates a condition in which the adhesive tape 14 of the adhesive tape roll 1 is attached to an object 4 before being cut by the second cutting member 22. In operation, the unrolled end portion 11 of the adhesive tape 14 of the adhesive tape roll 1 is first attached to the object 4 to a desired extent, and is subsequently cut by the second cutting member 22 by pressing the arcuate arm 28′ against the unrolled end portion 11 of the adhesive tape 14.

With the inclusion of the sleeve body 2 in the adhesive tape cutting device of this invention, the aforesaid drawback associated with the prior art can be eliminated. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An adhesive tape cutting device comprising:
a sleeve body adapted to be sleeved on an adhesive tape roll and defining a channel that has opposite first and second open ends which open in opposite circumferential directions for extension of the adhesive tape roll therethrough, said sleeve body further defining a tape-discharging slot that is disposed between said first and second open ends, that is in spatial communication with said channel, and that opens in a radial direction for extension of an unrolled end portion of an adhesive tape of the adhesive tape roll therethrough; and
a first cutting member mounted on said sleeve body.

2. The adhesive tape cutting device as claimed in claim 1, wherein said sleeve body includes upper and lower walls and a side wall interconnecting and cooperating with said upper and lower walls to define said channel and said first and second open ends, said first cutting member being mounted on said upper wall, said tape-discharging slot being formed in said upper wall.

3. The adhesive tape cutting device as claimed in claim 2, wherein said sleeve body further includes a cover that is disposed opposite to said side wall and that is detachably connected to said upper and lower walls.

4. The adhesive tape cutting device as claimed in claim 2, wherein said upper wall is formed with a cutter-mounting protrusion that protrudes radially therefrom and that has a tapered end formed with a first cutter-retaining slit, said first cutting member extending into said first cutter-retaining slit.

5. The adhesive tape cutting device as claimed in claim 2, further comprising an urging member mounted on said lower wall and extending into said channel for urging an outer surface of the adhesive tape roll to abut against said upper wall.

6. The adhesive tape cutting device as claimed in claim 5, wherein said lower wall is formed with a retaining slit, said urging member being in the form of a plate that has an arcuate spring arm portion which extends circumferentially into said channel and which is adapted to abut resiliently against an inner surface of the adhesive tape roll, and a bent end portion turned from an end of said spring arm portion and extending into said retaining slit.

7. The adhesive tape cutting device as claimed in claim 4, further comprising a-second cutting member mounted on said upper wall and displaced angularly from said first cutting member.

8. The adhesive tape cutting device as claimed in claim 7, wherein said upper wall is formed with a pivot protrusion, said sleeve body further including a cutter-mounting seat pivoted to said pivot protrusion and formed with a second cutter-retaining slit, said second cutting member extending into said second cutter-retaining slit.

9. The adhesive tape cutting device as claimed in claim 8, wherein said tape-discharging slot is disposed between said pivot protrusion and said cutter-mounting protrusion, said cutter-mounting seat including an arcuate arm pivoted to said pivot protrusion and extending therefrom toward said cutter-mounting protrusion, said second cutting member being disposed between said first cutting member and said tape-discharging slot.
